(19) United States
(12) Patent Application Publication
(10) Pub. No.: US 2026/0231877 A1
(43) Pub. Date: Aug. 13, 2026

(54) CULTIVATION SYSTEM AND PROCESS

(71) Applicant: JPWORKS S.R.L., Milano (IT)

(72) Inventor: Gian Paolo Mascetti, Milano (IT)

(21) Appl. No.: 19/115,526

(22) PCT Filed: Sep. 27, 2023
(86) PCT No.: PCT/EP2023/076730

§ 371 Date: Mar. 26, 2025

(30) Foreign Application Priority Data
Sep. 27, 2022 (IT) 102022000019779
Sep. 27, 2022 (IT) 102022000019782

(51) Int. Cl. A01G 24/44; A01C 1/04; A01G 7/04; A01G 24/48

(52) U.S. Cl. CPC A01G 24/44; A01C 1/04; A01G 7/045; A01G 24/48

(57) ABSTRACT

A cultivation system (1) comprising at least one containment cell (4) for germination and growth of cultivations (30). The at least one containment cell (4) comprises: a base cartridge (2) comprising a substrate (20) including seeds (3) and nutrient substances (8); an outer container (40) containing the a base cartridge (2); a closing system (41) associated with the outer container (40), the closing system (41) being transparent; wherein the at least one containment cell (4) is configured for containing the cultivations (30) during growth at least up to development, and wherein the at least one containment cell (4) is at least locally permeable to air and is configured for being crossed by an airflow. A related cultivation process.

### FIELD OF THE INVENTION

The present invention relates to a cultivation system and to a related cultivation process.

In general, the present invention finds application in the field of germination and growth of cultivations on substrates, in particular substrates of inert spongy materials, which include seeds and nutrient substances.

### PRIOR ART

Hydroponic cultivations are known, which are cultivations not on the soil but on special inert substrates.

In hydroponic cultivations, water, light and nutrients can be strictly controlled.

Hydroponic cultivations have the important advantage of being able to be made even in urban environments on structures with overlapping shelves. Consequently, thank to hydroponic cultivations, it is possible to obtain large cultivation areas on a small floor surface. The hydroponic cultivations, or similar vertically distributed systems, are also known as “vertical-farming” or “sky-farming”.

In addition, hydroponic cultivations, or in general non-soil cultivations, allow to reduce water and nutrients used for cultivation, even by more than 90%. In fact, if on the one hand in the traditional cultivations on the soil, water and nutrients are distributed very approximately, at the limit of chance, in hydroponic cultivations, nutrients and water are instead distributed in a more precise manner.

Document WO2019/056057A1 relates to an automated vertical farming apparatus for sequential carriage of growth trays around and through a mechanized, multi-level farming structure having an entry side or path and an exit side or path for said growth trays of a crop.

Document WO2020/239185A1 relates to a vertical farming robot, comprising one or more stacks of trays, each tray accommodating growth medium, where each tray is arranged one over the other on separate bearing means, and where a lifting bridge is arranged adjacent the one or more stacks of trays.

Document WO2022/034236A1 relates to a vertical farming system comprising: a plurality of tray-receptacles having a tray-surface area for a soilless growing environment for plants, a vertical supporting structure arranged and adapted to accommodate the plurality of tray-receptacles, a tray-receptacle transport device and an airflow-ducting device to transport an airflow.

Document DE102017102081A1 relates to a seed unit with a tablet made of pressed water-storing material, with seeds and nutrient beads and with a covering for the tablet and for the seeds made of a water-soluble material. Document WO2013/123447A1 relates to a plant growing system comprising a biodegradable outer shell, a rooting media, a fertilizer or nutrient, seeds, and a removable lid.

Document AU525073B2 relates to a seed planting device comprising: a seed head having a hollow manifold provided with a seed plate; a source of air under pressure and a source of suction; a plurality of spaced tubular nozzles positioned on the seed plate in a predetermined pattern, each of which extends from the seed plate, so as to simultaneously plant a plurality of seeds in a predetermined pattern in a seed bed.

Document WO2021/121445A1 relates to an indoor plant cultivation system comprising: an indoor plant cultivation device comprising at least one cultivation unit, containing a rack for receiving and positioning a plant cultivation capsule; the plant cultivation capsule is provided with at least one computer-readable code and contains a waterproof capsule shell, a water-holding layer, a water-guiding layer, and a plant-seed containing layer.

Document WO2019/243004A1 relates to plant growing cabinet comprising a body; at least one tray with a perforated base, suitable for placing therein the turf mixture enabling cultivated plants to grow; at least one plant growth unit in which, during watering of the plants, nutrition liquid is transmitted into the unit, the liquid passing through perforations of the at least one tray placed in the unit, entering the tray and humidifying the turf mixture; a lid placed on the tray, enabling forming the relative humidity conditions suitable for germination of plants by entrapping the liquid evaporating from the turf mixture in the volume in between itself and the tray; at least one vent cover provided on the lid, enabling the user to adjust air flow rate there through; at least one fan enabling air circulation in the body; and at least one display device positioned so as to view the lid from above.

The prior art described comprises some relevant drawbacks.

In fact, non-soil cultivation systems, compared to traditional soil cultivations, are very fragile, both structurally and biologically.

It follows that non-soil cultivation systems made manually at amateur level are very complex to be maintained efficiently and reliably, and hardly achieve the desired results.

Conversely, non-soil cultivation systems made industrially are very complex and expensive and, in order to become economically and ecologically advantageous, must be made with significant monetary and technological investments.

### SUMMARY OF THE INVENTION

In this situation, a technical task underlying the present invention is to devise a cultivation system capable of substantially remedying drawbacks of the prior art.

Within the scope of said technical task, an object of the present invention is to provide a cultivation system that enables non-soil cultivation to be made by individual operators, shops or smaller industrial companies.

A further particular object of the present invention is to provide a cultivation system which carries out a healthier and more productive non-soil cultivation.

A further particular object of the present invention is to provide a cultivation system achieving a better result in terms of crop quality.

A further particular object of the present invention is to provide a cultivation system yielding to a qualitatively better product.

A further particular object of the present invention is to provide a robust cultivation system with very low maintenance requirements.

A further particular object of the present invention is to provide a cultivation system which is more friendly to the environment.

A further particular object of the present invention is to provide cultivation system which is less expensive.

These and other objects are achieved by a cultivation system and a cultivation process according to the features of the appended claims, which form an integral part of the present description.

An idea underlying the present invention is to provide a cultivation system comprising at least one containment cell for germination and growth of cultivations.

The at least one containment cell comprises a base cartridge comprising a substrate including seeds and nutrient substances.

The at least one containment cell comprises an outer container containing the base cartridge.

The at least one containment cell comprises a closing system associated with the outer container, the closing system being transparent.

The at least one containment cell is configured for containing the cultivations during growth at least up to development.

The at least one containment cell is at least locally permeable to air and is configured for being crossed by an airflow.

A further idea underlying the present invention is to provide a cultivation process for germination and growth of cultivations.

The cultivation process comprises inserting a base cartridge in an outer container of a containment cell, the base cartridge comprising a substrate including seeds and nutrient substances.

The cultivation process comprises watering the substrate with a predetermined amount of water.

The cultivation process comprises closing the containment cell by associating a closing system to the outer container, the closing system being transparent.

The cultivation process comprises illuminating the containment cell.

The cultivation process comprises crossing with an airflow the containment cell, the containment cell being at least locally permeable to air.

The cultivation process comprises containing the cultivations in the containment cell during growth at least up to development.

Advantageously, the present invention allows a modular approach to non-soil cultivation, which is optimized in any cultivation phase.

In particular, the present invention is more effective in the preparation of the substrate with seeds.

The present invention is also more effective in carrying out germination and growth of cultivations in the containment cells.

The present invention is also more efficient for water, light and nutrients usage for cultivation.

The present invention achieves an improved crop yield and quality.

The present invention is more effective in distribution of products, which can be distributed in the same containment cell.

The present invention is also more environmentally friendly.

Further features and advantages will become more apparent from the detailed description given here below of examples and preferred non-limiting embodiments of the present invention and from the dependent claims which outline preferred and particularly advantageous embodiments of the invention.

### BRIEF DESCRIPTION OF THE FIGURES

The features and advantages of the invention are hereafter clarified by the detailed description of preferred and non-limiting embodiments of the invention, with reference to the attached drawings, wherein:

FIG. 1 shows a cultivation system according to the invention;

FIG. 2 shows a containment cell and a base cartridge, part of the cultivation system according to the invention;

FIG. 2B shows an alternative view of the containment cell and base cartridge of FIG. 2;

FIG. 3 shows a portion of a base cartridge, part of the cultivation system according to the invention;

FIG. 3B shows an exploded view of a base cartridge, part of the cultivation system according to the invention;

FIG. 3C shows an alternative to FIG. 3 of a portion of a base cartridge, part of the cultivation system according to the invention;

FIG. 4 shows a base cartridge, part of the cultivation system according to the invention;

FIG. 5 shows a containment cell, part of the cultivation system according to the invention;

FIG. 5B shows the containment cell of FIG. 5, inserted in the growth device which is as well part of the cultivation system according to the invention;

FIG. 6 Shows a seeding device, part of the cultivation system according to the invention;

FIG. 7 shows a preparation device, part of the cultivation system according to the invention;

FIG. 8 shows a growth device, part of the cultivation system according to the invention;

FIG. 9 shows a portion of the growth device of FIG. 8;

FIG. 9B exemplifies a first operation of aeration means in the growth device of FIG. 8;

FIG. 9C exemplifies a second operation of aeration means in the growth device of FIG. 8.

In the different figures, analogous elements will be identified by analogous reference numbers.

Moreover, in the figures, if there is a plurality of elements which are similar to each other, only one (or only some) of them will be indicated by a reference number for greater clarity; the other similar elements, although not indicated by a suitable reference number, are to be understood as included by analogy.

### DETAILED DESCRIPTION OF THE INVENTION

In this disclosure, the measurements, the values, the shapes and the geometric references (such as perpendicularity and parallelism), when associated with words such as “about” or other similar terms such as “almost” or “substantially”, are to be understood as excluding measurement errors or inaccuracies due to production and/or manufacturing errors and, above all, unless there is a slight deviation from the value, measurement, shape or geometric reference to which it is associated. For example, such terms, when associated with a value, preferably indicate a deviation of no more than 10% of the value itself.

In addition, when used, terms such as “first”, “second”, “upper”, “lower”, “primary” and “secondary” do not necessarily identify an order, a priority of relationship or relative position, but they can simply be used to more clearly distinguish among different components.

Unless otherwise specified, as is clear from the following discussions, it is considered that terms such as “processing”, “IT”, “determination”, “calculation”, or the like, refers to the action and/or processes of a computer or similar electronic computing device that manipulates and/or transforms data represented as physical ones, such as electronic quantities of registers of a computer system and/or memories into, other data similarly represented as physical quantities within computer systems, registers or other information storage, transmission or display devices.

The measurements and the data reported in this text are to be considered, unless otherwise indicated, as carried out in ICAO International Standard Atmosphere (ISO 2533:1975).

With reference to the Figures, the cultivation system according to the invention is globally indicated with the number 1.

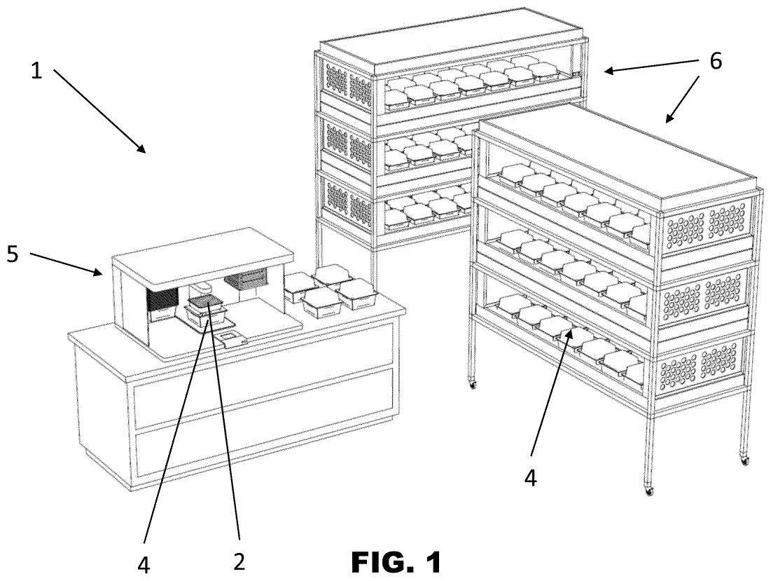

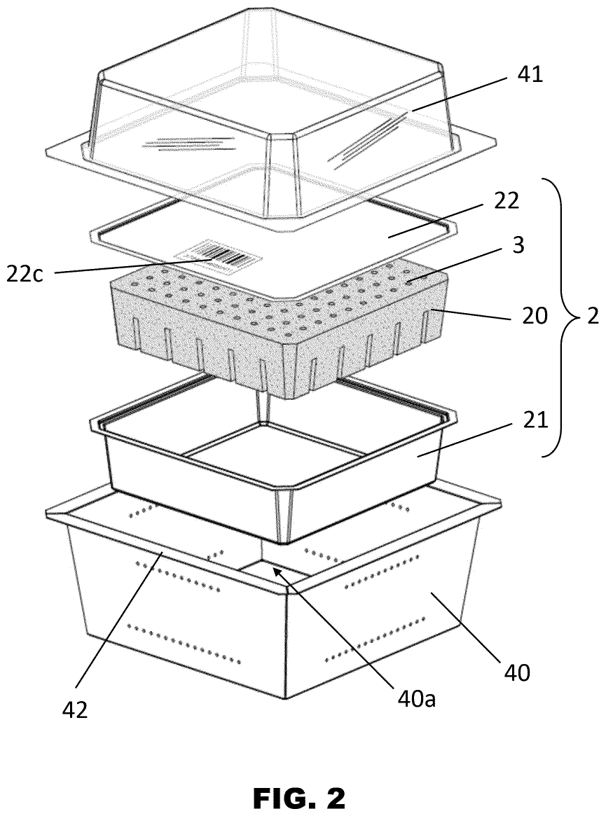

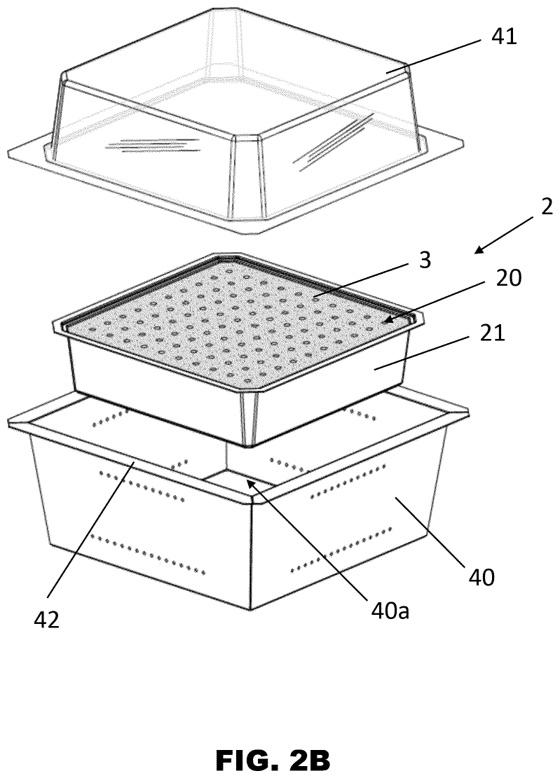

It preferably comprises, briefly, one or more of the following elements (FIG. 1 and FIG. 2):
a base cartridge 2, for containing seeds 3,
at least one containment cell 4, configured for allowing the containment of the base cartridge 2 at least in the germination and growth phases up to development,
a preparation device 5 for said at least one containment cell 4,
and a growth device 6 for hosting the at least one containment cell 4 during the germination and growth phases.

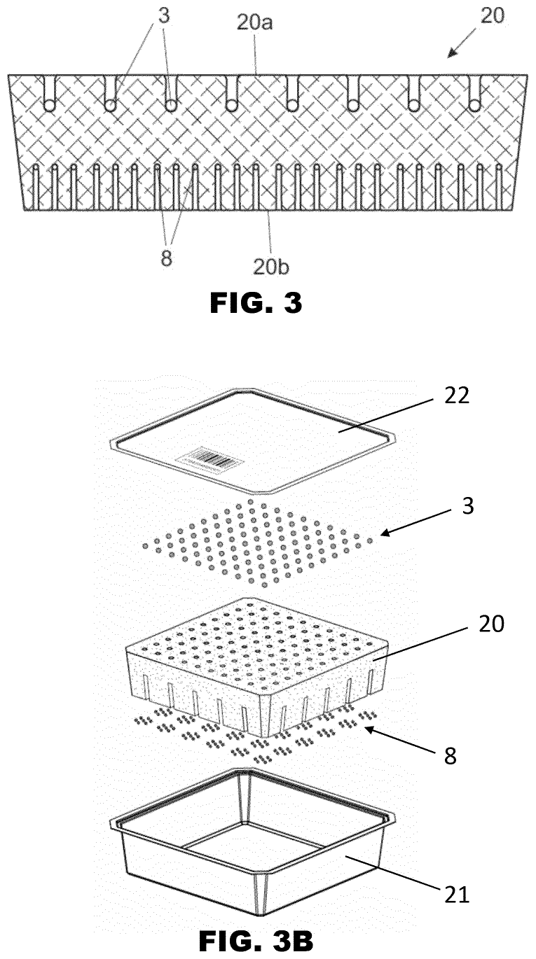

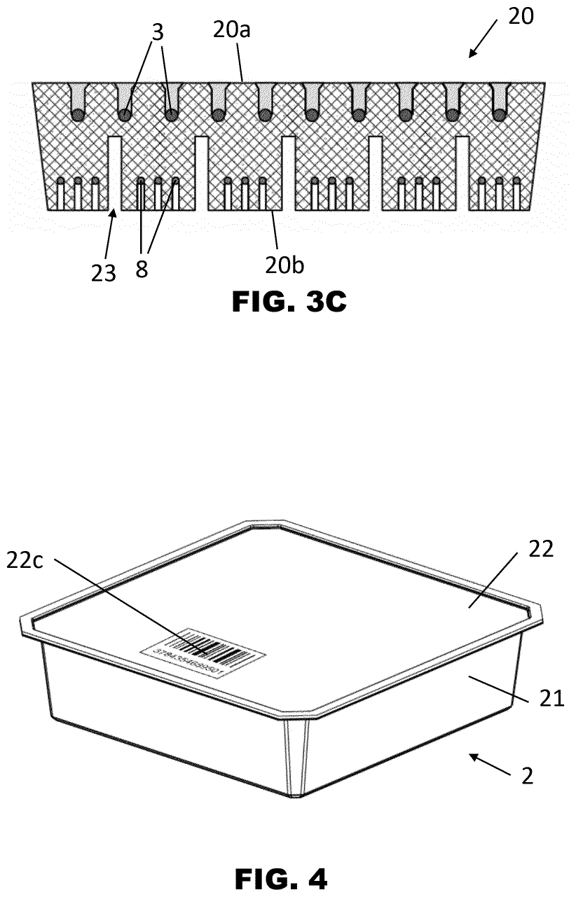

More in detail, and preferably, the base cartridges 2 (FIG. 2, FIG. 3B, FIG. 4) are configured for containing the seeds 3 and the nutrients 8 before the start of the cultivation process, and housing the plants during germination and growth, up to final use of the crop.

These base cartridges 2 preferably comprise a substrate 20 (FIG. 3) of inert spongy material, for example of aminoplast resin foam; in a non-limiting example, the inert spongy material can be Fytocell or have other suitable chemical compositions. In possible variants, the base cartridges 2 could comprise a substrate made of other suitable materials, for example a substrate of pressed soil or a substrate of bio-material capable of hosting cultivations and inserted in a receptacle. In general, the substrate can be of compact or loose material.

The substrate 20 is preferably contained in an inner container 21, for example box-like shaped and for example made of polymeric material.

The inner container 21 is preferably configured to act as a barrier for water which is inserted in the base cartridge 2 to hydrate the substrate 20. In this way, once the base cartridge 2 is inserted in the containment cell 4, the water will not seep outside of the containment cell 4.

The inner container 21 is preferably in recyclable or recycled material, such as plastic or biopolymer.

The substrate 20 defines two main faces: an upper face 20a, facing the opening of the container 21, and a lower face 20b, arranged at the bottom of the container 21. The two faces 20a and 20b, in use of the base cartridge 2, are preferably arranged parallel to a horizontal plane.

The lower face 20b may be flat or comprise recesses 23 or the like (FIG. 3C). These recesses 23 on the lower face 20b of the base substrate 20 provide a larger surface area available for roots to grow towards the bottom of the container 21, enhancing and favouring the root's action (oxygenation and hydration).

The substrate 20, preferably, comprises the seeds 3, which can be positioned individually or grouped into elements comprising a plurality of seeds. The seeds 3 in a same substrate 20 are preferably all the same vegetable.

The seeds 3 are preferably arranged in the depth of substrate 20, according to predetermined positions along the upper face 20a (FIG. 3B). The seeds 3 are also preferably arranged in regular positions, for example forming a square or hexagonal grid or other, so that the seeds 3 have the same distance from each other.

Furthermore, the seeds 3 are preferably arranged in the depth of substrate 20, according to predetermined positions along the direction parallel to the upper face 20a. In other words, the seeds 3 are preferably arranged at uniform and predefined depth within the substrate 20.

Preferably, within the substrate 20, there are no multiple seeds 3 aligned along the direction perpendicular to the upper face 20a, so the arrangement determined in this perpendicular direction is exclusively the determination of the depth of a single layer, with respect to the upper face 20a, of the position of the seed 3, which depth inside the substrate 20 is preferably identical for all seeds 3.

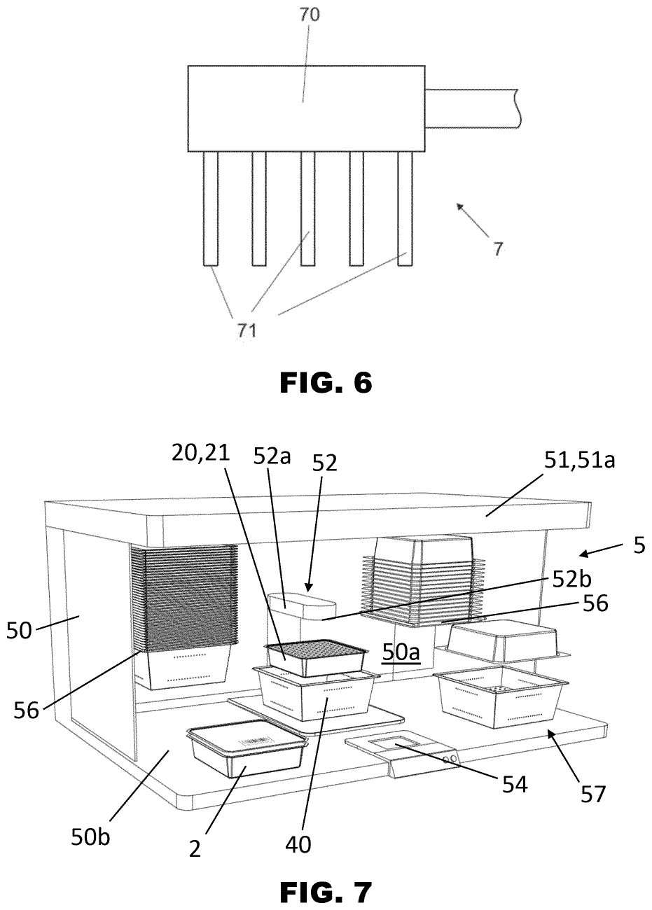

Preferably, the seeds 3 are installed in their positions by means of a seeding device 7 (FIG. 6), including a gripping unit 70, which comprises at least one cannula 71 within which the gripping unit is configured for creating a negative pressure (less than atmospheric). The seeding device 7 moves the cannula 71 on Cartesian axes and is configured for: arranging the cannula into a container including a plurality of seeds 3 and creating the vacuum inside the cannula 71 so that each cannula 71 sucks up a seed 3. The seed 3 and the cannula 71 are of such respective dimensions that, suitably, the seed 3 is stopped at the mouth of the cannula 71 and is retained therein by effect of negative pressure.

The seeding device 7 then arranges the cannula 71 including the seed 3 at one of said determined positions and the position, preferably along the upper face 20a and more preferably also perpendicularly thereto, entering the substrate 20, which the cannula 71 pierces easily, up to the desired depth inside the substrate 20 itself.

Each gripping unit 7 may comprise a matrix or grid of cannulas 71, having main axes arranged parallel and ends aligned along a plane, so that each insertion operation corresponds to the creation of a portion of the grid in which the seeds 3 are positioned.

The substrate 20 preferably also comprises nutrient substances 8 (FIG. 3, FIG. 3B, FIG. 3C). The nutrient substances 8, which comprise elements the seeds need for germination and growth, such as by way of example: nitrogen, phosphorus and potassium, are preferably positioned grouped into approximately spherical bodies and may be the same or different from each other in terms of composition of elements. Such nutrient substances are solid or granular i.e., single or conglomeration of, nutrient elements and are also marketed as agricultural fertilizers.

The nutrient substances 8 are preferably arranged at determined positions in the depth of substrate 20, preferably along the lower face 20b. The nutrient substances are also preferably arranged in regular positions, for example forming a square or hexagonal grid or other, so that the nutrients substances 8 have the same distance from each other.

In particular, the nutrient substances 8 are arranged at uniform and predefined depth within the substrate 20.

The arrangement of the seeds 3 can thus be the same or different than the arrangement of the nutrient substances 8.

In addition, different individual nutrient substances 8 may be provided, each consisting of different elements, for example one with nitrogen, one with potassium and so on. Their position, quantity and type may also preferably vary depending on the position, quantity and type of the seeds 3.

In addition, the nutrient substances 8 are preferably arranged in the depth of substrate 20, according to determined positions along the direction parallel to the lower face 20b or in any case parallel to the face through which they were positioned. Preferably, within the substrate 20, there are no nutrient substances 8 aligned along the direction perpendicular to the lower face 20b, so the arrangement determined in this perpendicular direction is exclusively the determination of the depth of a single layer, with respect to the upper face 20a or lower face 20b, of position of the nutrient substances 8, which depth inside the substrate 20 is preferably identical for all the nutrient substances 8.

Preferably, the nutrient substances 8, preferably grouped into approximately spherical bodies, are installed in such positions by means of the described seeding device 7, having cannulas 71 of appropriate dimension and at appropriate reciprocal distances.

The substrate 20 containing the seeds 3 and the nutrient substances 8, and not yet hydrated, is arranged in the container 21 which is then preferably sealed with a covering membrane 22 (FIG. 2).

The covering membrane 22, in a preferred embodiment, comprises a lid. Preferably such lid 22 is made of the same material as the container 21.

The covering membrane 22, in a non-limiting alternative, preferably comprises an outer membrane made of air impermeable material, such as PET or other polymers. The covering membrane 22 may further comprise an inner sheet, preferably printable, and preferably comprising the indication of the plant that can originate from the implanted seeds.

The covering membrane 22, in a non-limiting embodiment, also preferably comprises a code 22c easily readable by computer, such as a bar code or a QR code or the like.

The dedicated production line for the base cartridges 2 is designed to ensure a “clean chain” throughout the production process of the base cartridges 2. The seal between container 21 and covering membrane 22 is preferably made in a controlled atmosphere, so that the base cartridges 2 do not include polluted air or other contaminants.

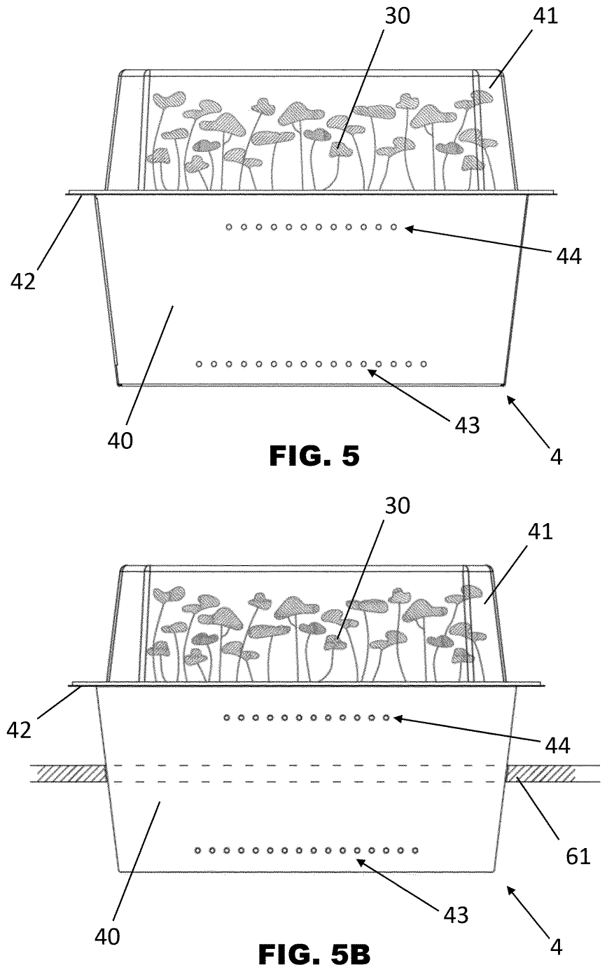

The containment cell 4 (FIG. 2, FIG. 2B, FIG. 5, FIG. 5B) is configured for allowing the containment of the base cartridge 2 (FIG. 4) in the germination and growth phase of the cultivations, at least up to the optimal development phase and advantageously into subsequent phases, preferably up to consumption.

Specifically, the containment cell 4 (FIG. 5, FIG. 5B) is configured for containing the base cartridge 2 and the cultivations 30 up to desired growth. Thus, the containment cell 4 effectively acts as a greenhouse during germination and growth phase, and also acts as a packaging container for the cultivations 30, even up to consumption.

The containment cell 4 comprises an outer container 40 (FIG. 2, FIG. 2B, FIG. 5, FIG. 5B), preferably slightly larger in size than the inner container 21 (FIG. 3B) and similar in shape, so as to contain it.

The outer container 40 comprises an open upper face 40a, and in use near the upper face of the inner container 21.

The outer container 40 also has a height, in a direction perpendicular to the upper face 40a, greater than the height of the inner container 21 and could have side windowing.

The outer container 40 preferably has a reflective inner surface. For example, it can be made by coupling kraft cardboard and reflective film, possibly with other layers.

The outer container 40 is designed so that it can allow a controlled permeability of the containment cell 4 to be obtained.

Specifically, the containment cell 4 is at least locally permeable to air and is configured for being crossed by an airflow.

The airflow crossing the containment cell 4, advantageously, allows to provide an enhanced and strictly controlled local environment for the substrate 20 and the cultivation 30.

The containment cell 4 preferably also comprises a closing system 41 (FIG. 2, FIG. 2B, FIG. 5, FIG. 5B) by means of a lid or film, associable with the outer container 40.

The closing system 41 preferably has shape and dimensions, in the plane of the upper face 40a, identical to the shape and dimensions of the outer container 40.

The closing system 41 is preferably transparent. It can be made of polymeric material such as PET, preferably recycled or recyclable. The closing system 41, in particular, is configured for allowing illumination of the substrate during growth of cultivation 30.

The containment cell 4 preferably comprises connection means 42 with substantial airtightness between the outer container 40 and the closing system 41. The connection means 42 are configured for providing a hermetic closure and preferably are provided by mechanical connection (interlocking) or with other sealing techniques, such as welding or gluing. The base cartridge 2 is placed in the containment cell 4 after the covering membrane 22 has been removed and after the substrate 20 has been hydrated.

As mentioned, the containment cell 4 is at least locally permeable to air and is configured for being crossed by an airflow, during growth of cultivations 30. In particular, the airflow crossing the containment cell 4 allows air circulation throughout the containment cell 4.

For providing local controlled permeability to air in the containment cell 4 and airflow circulation throughout the containment cell 4, at least one first opening 43 and at least one second opening 44 are provided in the containment cell 4 itself.

The containment cell 4 comprises at least one first opening 43 configured for inflow of air, and further comprises at least one second opening 44 configured for outflow of air.

In particular, a pressure differential acting at the interface with the at least one first opening 43 and the at least one second opening 44 allows to provide an airflow crossing the internal volume of the containment cell 4, wherein cultivations 30 are located.

In this way, cultivations 30 benefit from a healthy environment provided by the airflow, which is preferably of filtered or otherwise purified air. In addition, the airflow circulation throughout the containment cell 4 is adapted to improve the growth environment of the cultivation, yielding to better results.

Preferably, each of the at least one first opening 43 and/or at least one second opening 44 comprise a plurality of holes. In possible variants, larger holes or slits could be provided.

Preferably, the at least one first opening 43 is located at a lower position within the containment cell 4, while the at least one second opening 44 is provided at a higher position within the containment cell 4. Namely, the higher position is located higher than the lower position.

Preferably, the at least one first opening 43 and at least one second opening 44 are configured to be separated on the outside of said containment cell 4 by an external partition 61, such as a portion of a growth unit in a growth device which will be further described. A pressure differential can be provided across this external partition 61 associated to the containment cell 4, so as to provide an airflow crossing the volume of the containment cell 4. In particular, the at least one first opening 43 is configured for inflow of air, and the at least one second opening 44 is configured for outflow of air. Preferably, the airflow crossing the containment cell 4 allows air circulation throughout the containment cell 4.

Preferably, at least the at least one first opening 43 is provided in the outer container 40. Preferably, the at least one second opening 44 is also provided in the outer container 40.

In a variant, the at least one first opening 43 and/or the at least one second opening 44 may be provided on the closing system 41, in particular the lid 41.

In general, preferably, the containment cell 4 comprises a plurality of openings so as to be at least locally permeable to air and being crossed by an airflow. In an alternative, permeable material without openings (or having only micro-openings) can be provided to achieve analogous effect.

The cultivation system 1 may comprise a preparation device 5.

The preparation device 5 (FIG. 7) preferably comprises, briefly, a containment structure 50, aeration means 51, irrigation means 52 and an electronic processor, and other optional elements.

The containment structure 50 preferably has a box-like shape or the like, such as to define an internal volume 50a and to separate it by means of walls or the like, at least partially, from the external environment. Preferably, the containment structure 50 is provided with an opening 50b, which interrupts the continuity of the walls, for example at the front wall, so that the interior is accessible to a user.

The aeration means 51 are configured for sending purified air into the internal volume 50a and, suitably, for maintaining the same at pressure above the environmental pressure, so that environmental air does not enter the internal volume 50a similarly to the operation of the laminar flow cabinets.

The aeration means 51 comprise first filtering means 51a precisely for the purpose of maintaining the purified air in the internal volume 50a.

Preferably, the containment structure 50 comprises sanitizing light means, such as UVC lamps, configured for at least partially sterilizing surfaces around the internal volume 50a, especially before operation of the preparation device 5.

The irrigation means 52 are configured for supplying purified water through a nozzle 52b. The water is preferably taken from an aqueduct or from a basin outside the structure 50 and is preferably purified by means of second filtering means 52a. The irrigation means 52 also comprise control means of the nozzle 52a, preferably of the automatic type and functionally connected to the electronic processor.

In particular, the irrigation means 52 are configured for watering the substrate 20 only once before closing the containment cell 4 for growth of the cultivation 3. Moreover, the irrigation means 52 are configured for watering the substrate 20 with a predetermined amount of water, also depending on characteristics of the substrate 20 itself (size, type of seeds 3, etc.).

The electronic processor consisting of a computer, for example an Arduino® microcomputer or similar, or an external device, such as a computer, smartphone or tablet with special software connected, wireless or wired, with the preparation device 5. The electronic processor is configured for controlling, preferably, the aeration means 51 and the irrigation means 52 preferably automatically. To this end, the electronic processor can be connected to a reader 54, preferably inside the structure and part of the preparation device 5, configured for reading the code 22c and can comprise a screen and control means or be connectable, for example via Bluetooth, to an external device, such as a tablet or the like.

The containment structure 50 may also comprise supports 56 for outer containers 40 and for closing systems 41 and also a lighting system of the work area, for the containment structure 50 itself, preferably connected to the electronic processor.

The containment structure 50 may further comprise a sealing station 57 to facilitate the substantially airtight connection between the outer container 40 and the lid 41 through the connection means 42.

The containment cell 4, holding the base cartridge 2 which has been deprived of the covering membrane 22 and which has been properly hydrated, is sealed in the preparation device 5 and is then arranged in the growth device 6.

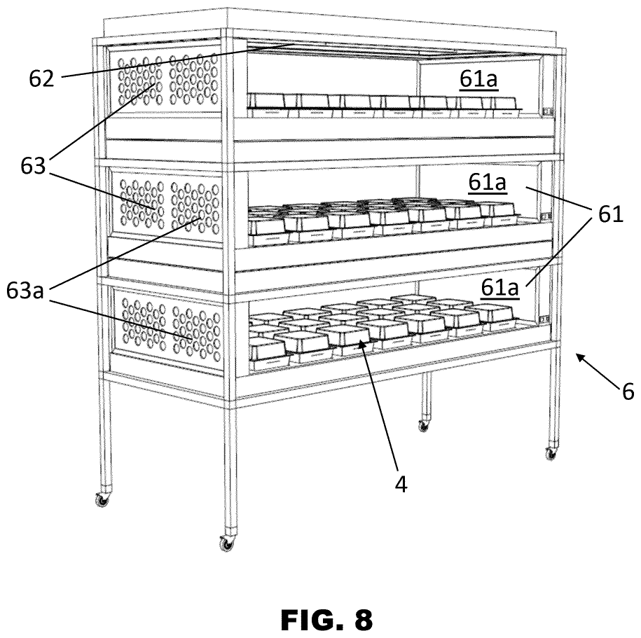

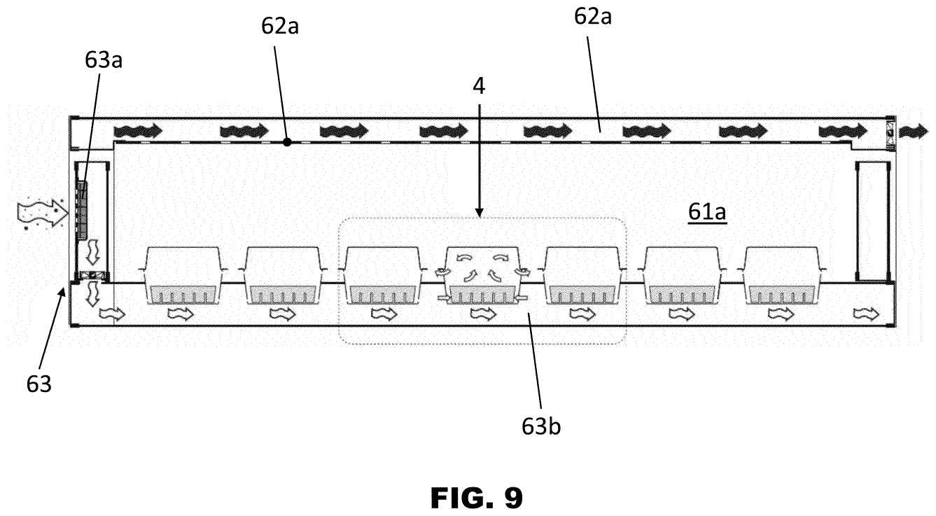

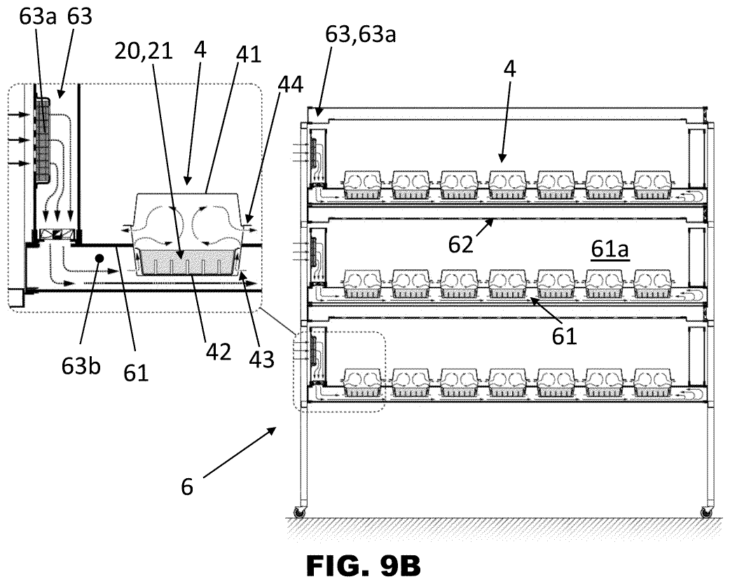

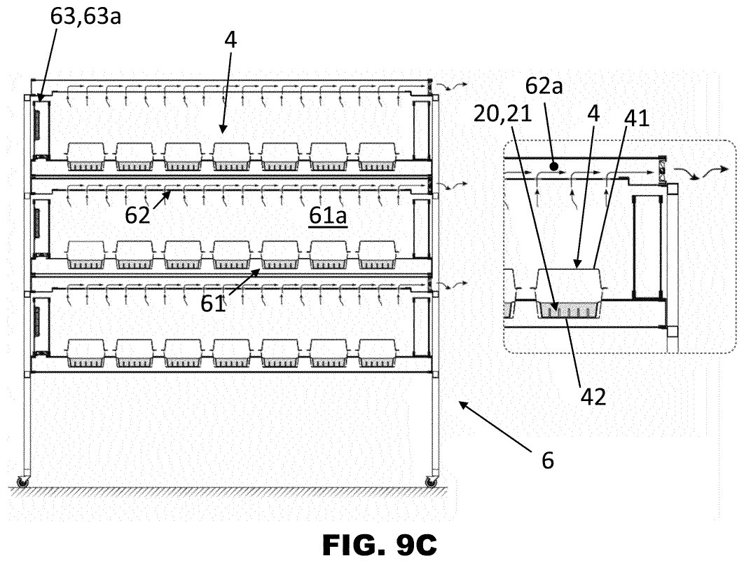

The growth device 6 (FIG. 8, FIG. 9) comprises a main structure 60 including, preferably, a series of growth units 61, preferably superimposed, each growth unit 61 defining a respective containment volume 61a for the hosting of closed and prepared containment cells 4.

Each growth unit 61 can be isolated with respect to the external environment and therefore can comprise doors or the like, preferably mirrored and/or transparent, in such a way as to guarantee a homogeneous and uniform illumination of the environment 61a.

The growth device 6 also comprises lighting means 62 and aeration means 63.

The lighting means 62 are preferably arranged within each containment volume 61a and are preferably each configured for illuminating the containment cells 4 with specially regulated, constant or time-varying light.

In particular, the lighting means 62 comprises light sources adapted for plant growth.

The lighting means 62 also comprise heat extraction means 62a of the lighting means, configured for limiting heating of the internal volume 61a due to the lighting means 62. The heat extraction means 62a preferably comprise a ventilation system of an upper interspace that also allows the creation of an upper air flow (FIG. 9), that in addition cools said lighting means 62. This upper airflow is particularly advantageous in the case of stacked growth units 61, because it limits undesired heating of upper growth units by heat generated in lower growth units.

The second aeration means 63 are configured for sending purified air to the containment cells 4 contained in the containment volume 61a. In particular, the aeration means 63 comprise an interspace 63b, in which the containment cells 4 are partially inserted, preferably in suspension (FIG. 9). Said interspace 63b is substantially a volume smaller than the containment volume 61a, defined by a substantially continuous lower plate, an upper plate with housings for the containment cells 4, and side walls.

The ventilation means 63 further comprise ventilation means that are configured for creating an air flow that crosses the entire interspace. The air that crosses the interspace passes through the containment cells 4, crosses them and flows out above.

Thus, by the pressure differential provided by the ventilation means 63 the containment cells are crossed by an airflow, in particular during growth of cultivations 30. Preferably, the airflow crossing the containment cell 4 allows air circulation throughout the containment cell 4, thereby improving the growth environment of the cultivations 30, for example in terms of oxygenation, humidity, sanitization, etc.

As already described, the containment cells 4 are at least locally permeable to air. The containment cell 4 preferably comprise at least one first opening 43 located, in operation, inside the interspace 63b for inflow of air. The containment cell 4 preferably comprise at least one second opening 44 located, in operation, outside of the interspace 63b and within the containment volumes 61a for outflow of air.

The pressure differential acting across the containment cells 4 in the growth device 6 allows providing an airflow crossing the enclosed volume occupied by cultivations 30.

The second aeration means 63 also comprise second filtering means 63a precisely for the purpose of keeping the air purified.

As mentioned, the airflow across the containment cells 4 is preferably of filtered or otherwise purified air. In particular, the filtering means 63a are not limited to mechanical filtering, but could include electrostatic filtering, UV light filtering (especially UVC), and so on.

The second aeration means 63 may also comprise a device for conditioning the temperature and/or the humidity of air in the interspace 63b.

The growth device 6 may also comprise an electronic processor consisting of a computer, for example an Arduino® microcomputer or the like, or an external device, such as a computer, smartphone or tablet with special software connected, wirelessly or via cable, with the growth device 6.

The electronic processor of the growth device 6 is configured for controlling the aeration means 63 and the lighting means 62 in coordination with each other, preferably in a cyclic manner so as to act synergistically and ensuring the optimal growing conditions for the cultivation 30.

The operation of the cultivation system 1 described above in structural terms is as follows. It also defines an innovative process of making a cultivation 30.

The base cartridges 2 are produced by inserting the seeds 3 and the nutrient substances 8 into the substrate 20 according to the described process and preferably by means of the seeding device 7. The substrate 20 is then inserted into the inner container 21 which is sealed closed by the covering membrane 22.

The base cartridges 2 can then be purchased by the user who for example also owns the preparation device 5 and/or the growth device 6.

The user who intends to cultivate using this system moves closer to the preparation device 5, scans, through the reader 54, the code 22c and opens the base cartridge 2 by removing the covering membrane 22.

The user places the base cartridge 2 in the outer container 40 and places the whole at the irrigation means 52. These operations can obviously also take place in the opposite order.

Preferably automatically, the irrigation means 52 insert the right amount of pure water after the electronic processor has recognized the type of seeds 3 and regulated the water emission.

The user seals the outer container 40 with the lid 41 and the connection means 42, preferably in the sealing station 57.

Throughout the operation, the aeration means 51 allowed the substrate 20 with seeds 3 to come into contact only with pure air, given the first filtering means 51a and the overpressure in the internal volume 50a.

The sealed containment cell 4 is then transported in the growth device 6 where it receives filtered and purified air and light of the type appropriate to the growth phase, preferably automatically thanks to the relative electronic processor.

Advantageously, the containment cell 4 acts as a container for the cultivation 30 and can be kept sealed up to time of consumption, ensuring a fresh taste and a safe preservation.

According to an aspect, the present invention relates to a base cartridge 2 for containing seeds 3.

Preferably, the base cartridge 2 comprises an inner container 21 for containing the substrate 20.

Preferably, the base cartridge 2 comprises a substrate 20 of spongy inert material.

Preferably, the substrate 20 defines two main faces: an upper face 20a, facing the opening of the container 20, and a lower face 20b, arranged on the bottom of the container 21.

Preferably, the base cartridge 2 comprises seeds 3 included in the substrate 20.

Preferably, the base cartridge 2 comprises nutrient substances 8 included in the substrate 20.

Preferably, the base cartridge 2 comprises a covering membrane 22 configured to airtight seal the base cartridge 2.

Preferably, the substrate 20 is initially non-hydrated, so as to leave the seeds unaltered until the opening of the covering membrane 22 and the hydration of the substrate 20.

Preferably, the container 20 is airtight.

Preferably, the seeds 3 are arranged in predetermined positions along the upper face 20a.

Preferably, the seeds 3 are arranged in regular positions along the upper face 20a forming a grid.

Preferably, the nutrient substances 8 are arranged in predetermined positions along the direction parallel to the upper face 20a.

Preferably, the covering membrane 22 comprises an outer membrane of air-impermeable material and a printable inner sheet.

Preferably, the nutrient substances 8 are grouped into approximately spherical bodies.

Preferably, the nutrient substances 8 and the seeds 3 are inserted into the substrate from opposite main faces.

According to a further aspect, the present invention relates to a seeding device 7 for making a base cartridge 2.

Preferably, the seeding device 7 comprises a gripping unit 70, comprising at least one cannula 71. The cannula 71 is preferably hollow.

Preferably, the gripping unit 70 is configured to create a negative pressure within the cannula 71.

Preferably, the cannula 71 is of such dimensions that the seed 3 is stopped at the opening of the cannula 71 and retained by the negative pressure.

Preferably, the cannula 71 is configured for entering the substrate 20.

Preferably, the gripping unit 7 comprises a grid of cannulas 71, having main axes arranged parallel to each other and ends aligned along a plane, so that each insertion operation corresponds to the creation of a portion of the grid in which the seeds 3 are positioned.

According to a further aspect, the present invention relates to a cultivation system.

Preferably, the cultivation system comprises a growth device 6 for containing cultivations 30 during growth.

Preferably, the cultivation system comprises at least one base cartridge 2, for containing seeds 3.

Preferably, the cultivation system comprises at least one containment cell 4, configured for allowing the containment of the base cartridge 2 for the germination and growth phases of the seeds 3.

Preferably, the cultivation system comprises a preparation device 5 of the containment cells 4.

Preferably, the base cartridge 2 comprises a substrate 20 including seeds 3 and nutrient substances 8 and non-hydrated. The substrate 20 is closed airtight by a covering membrane 22.

Preferably, the containment cell 4 is permeable to air and contains the base cartridge 2 having no covering membrane 22 and being hydrated.

Preferably, the growth device 6 is configured to host a plurality of the containment cells 4 during the germination and growth phases of the cultivations 30.

Preferably, the growth device 6 comprises a main structure 60 defining at least one containment volume 61a and including second ventilation means 63 configured for sending purified air into the cells of containment 4 contained in the containment volume 61a and for maintaining the same at a pressure higher than the environmental pressure.

Preferably, the growth device 6 comprises lighting means 62 arranged within each of the containment volume 61a and configured for illuminating with specially regulated light the containment cells 4.

Preferably, the growth device 6 comprises an electronic processor configured for controlling the growth device 6 automatically.

Preferably, the preparation device 5 comprises a containment structure 50 defining an internal volume 50a separated by walls from the external environment and an opening 50b, which interrupts the continuity of the walls.

Preferably, the preparation device 5 comprises ventilation means 51 configured for sending purified air into the internal volume 50a and for maintaining the same at a pressure above the environmental pressure, so that potentially contaminated environmental air does not enter the internal volume 50a.

Preferably, the preparation device 5 comprises irrigation means 52, configured for supplying purified water to the base cartridge 2.

Preferably, the preparation device 5 comprises an electronic processor configured for controlling the preparation device 5 automatically.

Preferably, the cultivation system comprises a seeding device 7, including a gripping unit 70, comprising at least one cannula 71 within which the gripping unit is configured for creating a negative pressure and, the cannula 71 being configured for entering the substrate.

According to a further aspect, the present invention relates to a cultivation process using a cultivation system 1.

Preferably, the cultivation system 1 comprises at least one base cartridge 2, for containing seeds 3.

Preferably, the cultivation system 1 comprises at least one containment cell 4, configured for allowing the containment of the base cartridge 2 for the germination and growth phases of the seeds 3.

Preferably, the cultivation system 1 comprises a growth device 6 configured to contain a plurality of the containment cells 4 during the growth of the cultivations 30.

Preferably, the cultivation process comprises making at least one base cartridge 2 comprising a substrate 20 including seeds 3 and nutrient substances 8 and non-hydrated, substrate 20 being airtightly closed by a covering membrane 22.

Preferably, the cultivation process comprises subsequent making of a containment cell 4 permeable to air and containing the base cartridge 2 deprived of covering membrane 22 and hydrated.

Preferably, the cultivation process comprises subsequent positioning of the containment cell 4 in the growth device 6 during the germination and growth phases of the seeds 3.

Preferably, the base cartridge 2 is provided by a first entity and the rest of the process is provided by a second entity.

### Industrial Applicability

The cultivation system and process according to the present invention allows to optimally grow cultivations up to the desired stage of growth.

Unlike the traditional cultivation systems (hydroponic and in soil) in the present invention, in order to avoid potential contaminations, the harvesting of cultivated product consists simply in the collection of the containment cells 4, without coming into direct contact with the plant.

The containment cells, once collected, also advantageously perform the function of packaging for distribution up to consumption.

The cultivated plant product therefore remains in the same growth environment until the consumption phase, without damaging the root or leaf areas and without incurring into contaminations by external agents.

The cultivation system 1 according to the invention achieves important advantages. In fact, the cultivation system 1 described makes it possible to carry out a complete cultivation cycle even for individual operators, shops or small industrial or social realities. It is in fact simple to use and, at the same time, economical and robust.

Moreover, the cultivation process according to the invention is extremely simplified for the user, by giving the possibility to be automatically alerted by a proprietary software when the plant is ready to be collected from the growth unit. The proprietary software is triggered by the preparation unit processor in the moment of the hydration of the base cartridge and automatically calculates the best time to collect and consume the plants.

Taking into consideration the herein provided description, the skilled in the art may devise further modifications and variants, in order to meet contingent and specific requirements. For example, the invention can be manufactured with different choices of materials.

Moreover, for example, the shapes and dimensions of the various elements, especially the base cartridges, can be varied.

In particular, it is evident that, in the absence of technical incompatibilities which are apparent to the skilled in the art, the configurations of specific elements described with reference to some Figures might be used in combination with other elements described in connection with other Figures.

1-20. (canceled)

21. A cultivation process for germination and growth of cultivations, said cultivation process comprising:
inserting a base cartridge into an outer container of a containment cell, said base cartridge comprising a substrate including seeds and nutrient substances;
watering said substrate with a predetermined amount of water;
closing said containment cell by associating a closing system to said outer container to define an enclosed volume of said containment cell, said closing system being transparent;
illuminating said containment cell;
pressurizing said enclosed volume; and
containing said cultivations in said containment cell during growth at least up to development.

22. The cultivation process of claim 21, wherein said containment cell comprises at least one first opening and at least one second opening, said cultivation process further comprising:
providing an inflow of air into said enclosed volume through said at least one first opening; and
providing an outflow of air out of said enclosed volume through said at least one second opening.

23. The cultivation process of claim 22, further comprising:
partially inserting said containment cell in an interspace of a growth device;
providing a pressure connection between said interspace and said at least one first opening; and
pressurizing said interspace to pressurize said enclosed volume.

24. The cultivation process of claim 23, further comprising:
positioning said at least one first opening inside said interspace; and
positioning said at least one second opening outside said interspace.

25. The cultivation process of claim 21, wherein said substrate is initially non-hydrated, so as to leave said seeds unaltered until watering of said substrate.

26. The cultivation process of claim 21, further comprising: watering said substrate only once before closing said containment cell.

27. A base cartridge for a cultivation system, said base cartridge comprising:
a substrate of spongy inert material, said substrate including seeds and nutrient substances, wherein said seeds are spaced and arranged in regular positions in said substrate, and wherein said nutrient substances are spaced and arranged in regular positions in said substrate;
an inner container for containing said substrate, said inner container being configured as a barrier for water inserted in said base cartridge; and
a removable covering membrane.

28. The base cartridge of claim 27, wherein said seeds and said nutrient substances are separated by said spongy inert material.

29. The base cartridge of claim 27, wherein said substrate is non-hydrated until removal of said covering membrane.

30. A cultivation system comprising:
at least one containment cell for containing cultivations during growth up to at least development; and
a growth device for hosting said at least one containment cell during germination and growth of said cultivations,
wherein said at least one containment cell comprises:
a base cartridge comprising a substrate including seeds and nutrient substances;
an outer container containing said base cartridge;
a closing system associated with said outer container to define an enclosed volume of said at least one containment cell, said closing system being transparent;
at least one first opening configured for inflow of air into said enclosed volume; and
at least one second opening configured for outflow of air out of said enclosed volume, and
wherein said growth device comprises:
a ventilation device configured for pressurizing said enclosed volume.

31. The cultivation system of claim 30, wherein said growth device comprises an interspace in which said at least one containment cell is partially inserted.

32. The cultivation system of claim 31, wherein said interspace provides a pressure connection between said ventilation device and said at least one first opening.

33. The cultivation system of claim 32, wherein said at least one first opening is located inside said interspace, and
wherein said at least one second opening is located outside said interspace.

34. The cultivation system of claim 33, wherein said at least one first opening is located at a lower position within said at least one containment cell, and
wherein said at least one second opening is provided at a higher position within said at least one containment cell.

35. The cultivation system of claim 31, wherein said ventilation device is configured for pressurizing said interspace to generate a pressure differential between said interspace and said enclosed volume, causing an airflow crossing said enclosed volume.

36. The cultivation system of claim 30, wherein said growth device comprises a lighting system configured for illuminating said at least one containment cell during said germination and growth.

37. The cultivation system of claim 36, wherein said growth device further comprises a heat extractor comprising a ventilation system, said heat extractor configured for extracting heat generated by said lighting system through an upper interspace.

38. The cultivation system of claim 30, wherein said growth device further comprises an air filter and/or air purifier connected to said ventilation device, said ventilation device being further configured for sending filtered and/or purified air to said enclosed volume.

39. The cultivation system of claim 30, wherein said at least one containment cell further comprises an airtight connection between said outer container and said closing system.

40. The cultivation system of claim 30, wherein said at least one first opening and/or said at least one second opening comprises one or more openings or permeable material, so as to be permeable to air and configured for airflow.
